(19) United States
(12) Patent Application Publication
(10) Pub. No.: US 2004/0260699 A1
(43) Pub. Date: Dec. 23, 2004

(54) Access management and execution

(75) Inventors: Yoshinori Aoki, Yokohama-shi (JP); Masayuki Numao, Kanagawa-ken (JP); Yuji Watanabe, Tokyo-to (JP); Madoka Yuriyama, Fujisawa-shi (JP)

Correspondence Address: Louis P. Herzberg, Intellectual Property Law Dept., IBM Corporation, P.O. Box 218, Yorktown Heights, NY, 10598, US

(73) Assignee: International Business Machines Corporation, Armonk, NY

(21) Appl. No.: 10/803,741

(22) Filed: Mar. 18, 2004

(30) Foreign Application Priority Data
Mar. 28, 2003 (JP) 2003-090138

(51) Int. Cl. G06F 7/00

(52) U.S. Cl. 707/9

(57) ABSTRACT

Provides access management methods and systems wherein privacy needs are taken into consideration. An example access management system of this invention includes an authorization engine, which controls access to a registrant database storing registrant data including privacy data of a registrant and controls the access to the registrant database by use of a given privacy policy and by use of condition data designated by the registrant. The authorization engine includes an authorization judgment unit, which decides an access type from an access request received from outside and concerning the registrant data, controls reference to the registrant database based on the access request by use of access authorization data to be decided prior to the access request regarding the access type.

### FIELD OF INVENTION

The present invention relates to management of access to a database which stores confidential personal data. It is more specifically directed to access management to effectuate reliable and high-speed processing. It also relates to access management for a registrant database storing personal data through a network while maintaining confidentiality.

### BACKGROUND OF THE INVENTION

In recent years, there are many cases where personal data such as client data or resident data are stored and saved in a database. Especially, as a network such as the Internet is put into general use, personal data such as privacy data will be accumulated in a registrant database installed in one management site. Access to the database storing an enormous amount of private data must be managed at a high security level so as to prevent unauthorized leakage of the highly confidential personal data. Therefore, various access management techniques have been offered heretofore.

For example, a situation is assumed in such a way that a company, a local government, or a national government (hereinafter referred to as a policy setter) collects registrant data of clients, residents, companies, or organizations (regardless of being commercial or noncommercial; hereinafter simply referred to as registrants) and saves the respective registrant data in a database. At this time, the data saved in the database needs to be treated at a high security level from the viewpoints of privacy protection and prevention of unlawful acts such as unlawful acquisition of right.

For this reason, the policy setter normally sets a policy concerning treatment of the collected registrant data as a privacy policy. This privacy policy may include descriptions as to who can use which information out of the collected registrant data for what purpose, for example. The policy setter facilitates processing for an operation data, while collecting the registrant data, so that a person who desires member registration may confirm the privacy policy set up by the policy setter, to input the privacy data by mutual agreement. When the policy setter treats the registrant data, it is considered necessary to arrange a mechanism to protect the registrant data by means of checking whether or not the responsible person in charge who intends to access the database has a proper access right so as to eliminate any access not satisfying the privacy policy concerning the registrant data.

### SUMMARY OF THE INVENTION

Thus, an aspect of the present invention is to provide access management methods and systems wherein privacy needs are taken into consideration. That is, an aspect of the present invention is to provide an access management system, an access management method, a control program for causing a computer to execute the access management method, and a computer-readable recording medium recording the control program, which ensures access to highly confidential data such as privacy data of registrants with high reliability and at a high security level.

Another aspect of the present invention is to provide an access management system and an access management method necessary for the above-described access management through a network.

In order to attain the above-described aspects, and focusing on the fact that privacy policies can be classified into elements depending on a policy setter and elements depending on registrants. The present invention is provided based on an idea that appropriateness checks with a registrant database using an authorization engine can be accelerated without degrading a security level, when it is possible to calculate access authorization data in advance and to adapt a calculated result to an access authorization by means of organizing the above-mentioned elements into independent lists or tables.

In an access management method according to an example embodiment of the present invention, access types for access to a registrant database is decided by using the elements dependent on the policy setter divided into data usage type by the person in charge (a data user) in the policy setter, and a business purpose type. In this way, an access type list to be used as the access authorization data is generated and stored in a storage area in advance.

Regarding the elements depending on the registrants, a cluster identification value for each registrant is registered based on condition data of an arbitrary number set by the registrant. In this way, a registrant condition table to be used as the access authorization data is generated. In the access management method according to this embodiment of the present invention, the access type is decided when the authorization engine receives an access request from an application. The authorization engine searches the access type list based on the decided access types, and obtains a consent pattern corresponding to the condition data.

Furthermore, according to the present invention, there is provided an access controlling method for controlling a computer to manage access to registrant data through a network. Here, the access management method includes the steps of: causing an authorization engine to use access authorization data calculated in advance through the network; causing the authorization engine to receive an access request from outside to a registrant database storing the registrant data containing privacy of the registrant; deciding an access type upon receipt of the access request from the outside; and controlling the access to the registrant database by comparing the decided access type with the access authorization data decided prior to the access request.

### BRIEF DESCRIPTION OF THE DRAWINGS

For a more complete understanding of the present invention and the advantages thereof, reference is now made to the following description taken in conjunction with the accompanying drawings.

FIGS. 1A and 1B are views showing data configurations for reference as privacy policies in an embodiment of the present invention.

FIGS. 2A to 2C are views showing data structures of an access type list and a registrant condition list which constitute access authorization data created in an access management system according to an example embodiment of the present invention.

FIG. 3 is a flowchart of the access management method according to the example embodiment of the present invention.

FIG. 4 is a flowchart showing a modified example of the access management method according to the example embodiment of the present invention shown in FIG. 3.

FIG. 5 is a view showing a restructuring example of the privacy policy to generate the access authorization data used in an access management method according to a second embodiment of the present invention.

FIG. 6 is a view showing reference axes to be applied when performing compression processing of a registrant condition table contained in the access authorization data which are usable in the access management method of the present invention.

FIG. 7 is a view schematically showing compression processing along an access type axis in the present invention.

FIG. 8 is a flowchart showing processing to be executed by an authorization engine when executing the access management method of the present invention by use of the data compression shown in FIG. 7.

FIG. 9 is a schematic diagram showing compression processing along a condition data axis, which is another embodiment of the data compression method in the present invention.

FIG. 10 is a flowchart showing processing to be executed by the authorization engine when using the access authorization data after execution of the compression processing along the condition data axis.

FIGS. 11A to 11C are views showing an outline of data compression processing along a registrant axis which is used in the present invention.

FIG. 12 is a flowchart showing the processing for adding and updating the access authorization data at runtime, which can be executed when using the access authorization data in the access management method according to the second embodiment of the present invention.

FIG. 13 is a flowchart showing primary processing of the access management method of the present invention until start of the processing of the access management method.

FIG. 14 is a view showing the preferred embodiment in which the registrant condition table is not created in advance but added dramatically.

FIG. 15 is a view showing the preferred embodiment in which a record is added dramatically when the registrant condition table is created for each access type in the access management method of the second embodiment of this invention.

FIG. 16 is a schematic functional block diagram showing an access management system according to the present invention where the access management method of the present invention is implemented.

FIG. 17 is a view showing an access management system according to a second embodiment of the present invention.

FIG. 18 is a view showing an access management system according to a third embodiment of the present invention.

FIG. 19 is a view showing a conventional access management system.

FIG. 20 is a view showing a data flow in the conventional access management system.

### DESCRIPTION OF THE INVENTION

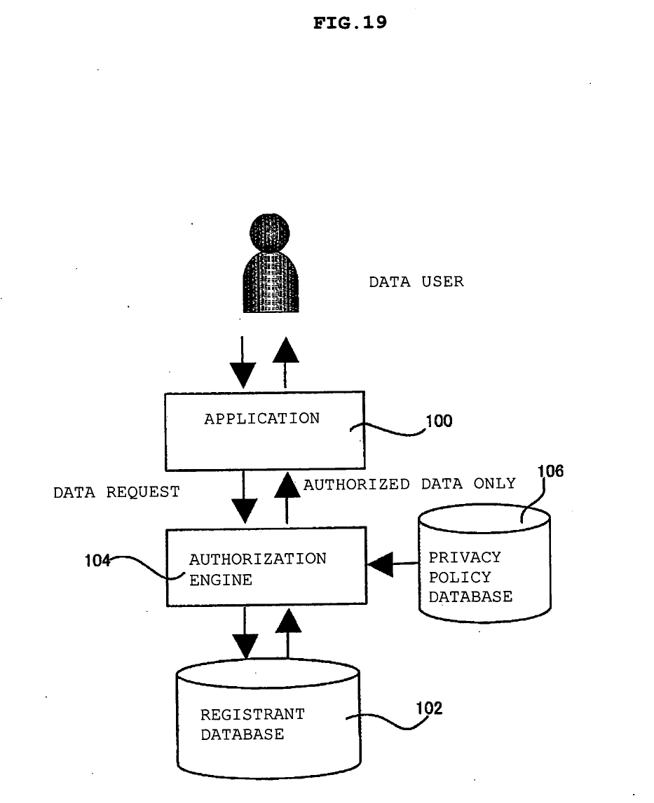

The present invention provides methods systems and apparatus for access management wherein privacy needs are taken into consideration. FIG. 19 shows an example of a conventional access management system in which the privacy needs to be taken into consideration. In FIG. 19, an authorization engine 104 is disposed between an application 100 and a registrant database 102. A person in charge, such as the policy setter, accesses the registrant database 102 through the application 100. Upon receipt of an access request from the person in charge, the authorization engine 104 makes reference to a privacy policy database 106 and judges the access right of the person in charge. In this way, the access management system is intended to prevent free and direct access to the registrant database by the person in charge without being checked whether or not having a proper access right. Concrete processing of the authorization engine 104 shown in FIG. 19 will be explained. When the authorization engine 104 receives the access request to registrant information from the application 100, the authorization engine 104 judges whether or not the access request satisfies the privacy policy. Moreover, when the authorization engine 104 judges that the access request satisfies the privacy policy, the authorization engine 104 facilitates a series of data processing that permits the person in charge to access the registrant database, enabling the person in charge to obtain registrant data, and returning the registrant data to the application.

As described above, it is possible to prevent the misuse of the privacy information of the registrants by judging whether or not the received access request satisfies the privacy policy in real time with the authorization engine 104. Hereafter, whether or not the access request satisfies the private policy will be checked or judged referring to “appropriateness check” in this invention. Consequently, judgment of satisfaction and subsequent issuance of an access permit will be hereinafter referred to as “authorization”. On the contrary, non-issuance of the access permit or generation of an access disapproval signal will be hereinafter referred to as “disapproval”.

In comparison with a usual access management system configured to access the registrant database 102 directly without using the authorization engine 104, access to the registrant database 102 through the authorization engine 104 as shown in FIG. 19 has a processing of “appropriateness check” added to the access management system.

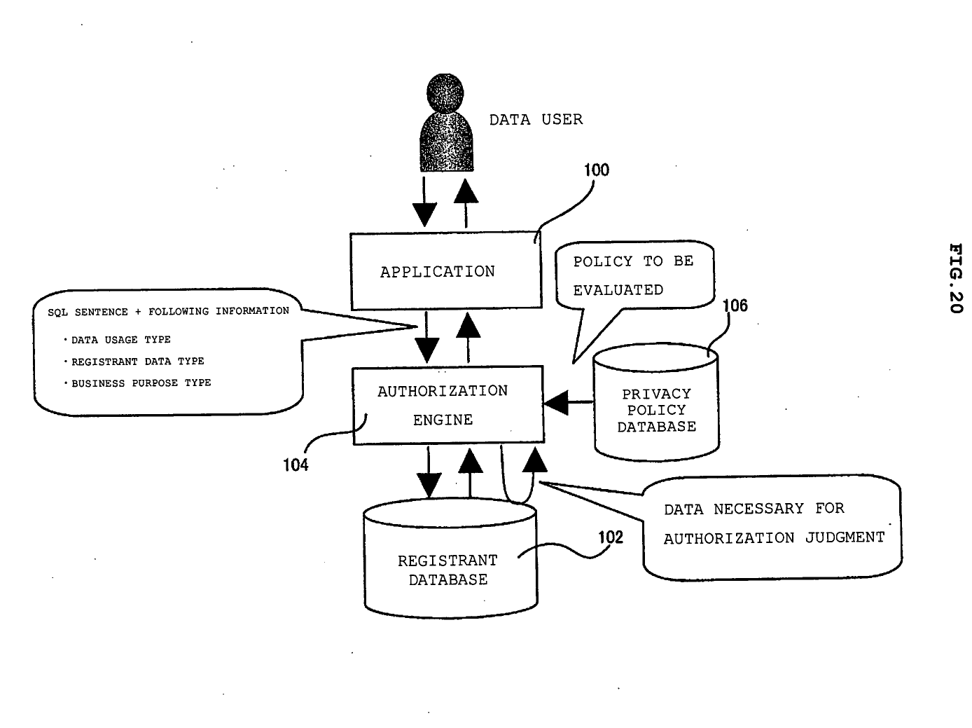

FIG. 20 shows a concrete example of data and processing to be used for the appropriateness check of the above-described privacy policy. In order to describe the conventional appropriateness check of the privacy policy shown in FIG. 19 more concretely, an operation that the policy setter sends direct mails (DM) will be taken into consideration in FIG. 20. Here, if assuming the situation such that a person in charge for marketing at the policy setter intends to obtain data of names and addresses of registrants satisfying a condition of “registrants with ages of 30 years or older and having addresses in xxx” out of the registrant database for the purpose of marketing of its own product, and the registrant database 102 is a relational database, an application execution unit 100 issues an access request in a format such as an SQL sentence to the authorization engine 104 with the condition that “registrants with ages of 30 years or older and having addresses in xxx”, then at this time, in addition to the SQL sentence, the access request may further include information such as person-in-charge identification data (a real name such as “Mr. A in charge of marketing”, an employee code, a password, or a user ID, for example), a type of registrant data required to be accessed (“a name, an address, a telephone number, and a fax number”, for example), a type of business which is the purpose of access (a “campaign”, for example), which are necessary for the appropriateness checks.

When receiving the access request, the authorization engine 104 executes the SQL sentence and receives a list of “names” and “addresses” of all registrants satisfying the condition of “registrants with ages of 30 years or older and having addresses in xxx”. Next, the authorization engine 104 searches all the policies to be evaluated with the privacy policy database 106 and thereby obtains policy data. Subsequently, the following procedures take place depending on each piece of the obtained registrant data. First, if assuming that there are 10,000 results for the words in the registrant data satisfying the condition of “registrants with ages of 30 years or older and having addresses in xxx” as a search result, the following calculations (1) and (2) will be executed concerning the “names” and the “addresses” of those 10,000 records.

(1) All the privacy policies to be evaluated are evaluated. At this time, if there are conditions other than the policies to be arbitrarily set by the registrants, then data necessary for judgment of the conditions are obtained in the course of evaluation of the privacy policies. For example, it may be necessary to retrieve the condition data recording an agreement of the registrants out of the registrant database and check whether or not the registrants have agreed in receiving DMs.

(2) A final evaluation result is calculated based on an evaluation result of the privacy policies to be evaluated. As a condition data logic for calculating the final evaluation result may include a variety of logic, such as AND logic which authorizes only when all the policies are OK, OR logic which authorizes when there is at least one policy is OK,. and the like. In aggregate, such judgment processing will be repeated by 20,000 times at the maximum including the processing for the calculations (1) and (2).

That is, when the appropriate checks are carried out in the access management system shown in FIG. 19 and FIG. 20, the overhead attributable to the processing for the appropriateness checks becomes an issue. Particularly, in the case of an application which accesses an enormous volume of registrant data at once, such as data mining by use of the registration database or an application for sending electronic mails or DMs as a part of a promotion campaign, the overhead becomes a more serious problem as the number of registrants climes. Therefore, serious problems are raised over operation efficiency on the policy setter side.

Therefore, there has been a demand for access management with high reliability and at a high security level with respect to highly confidential data such as the privacy data of the registrants.

The present invention overcomes the inconveniences described. That is, it provides an access management system, an access management method, a control program for causing a computer to execute the access management method, and a computer-readable recording medium recording the control program, which ensures access to highly confidential data such as privacy data of registrants with high reliability and at a high security level. Also provided is an access management system and an access management method necessary for the above-described access management through a network.

In order to attain these, the invention focuses on the fact that privacy policies can be classified into elements depending on a policy setter and elements depending on registrants. The present invention is based on an idea that appropriateness checks with a registrant database using an authorization engine can be accelerated without degrading a security level, when it is possible to calculate access authorization data in advance and to adapt a calculated result to an access authorization by means of organizing the above-mentioned elements into independent lists or tables.

In an access management method according to a example embodiment of the present invention, access types for access to a registrant database is decided by using the elements dependent on the policy setter divided into data usage type by the person in charge (a data user) in the policy setter, and a business purpose type. In this way, an access type list to be used as the access authorization data is generated and stored in a storage area in advance.

Meanwhile, regarding the elements depending on the registrants, a cluster identification value for each registrant is registered based on condition data of an arbitrary number set by the registrant. In this way, a registrant condition table to be used as the access authorization data is generated. In the access management method according to the example embodiment of the present invention, the access type is decided when the authorization engine receives an access request from an application. The authorization engine searches the access type list based on the decided access types, and obtains a consent pattern corresponding to the condition data. The cluster identification value to be authorized by the access type is searched by use of this consent pattern as a key. Discovery of the cluster identification value in the access authorization data includes the steps of instructing access authorization, obtaining the registrant data corresponding to the cluster identification value from the registrant database, and returning the registrant data to the application. Moreover, in the above-described configuration of the present invention, it is possible to use a method for dynamically constructing the access authorization data such as the access type list or the registrant condition table by allowing a high-speed access memory such as a cache memory to sequentially update the access authorization data at runtime.

Meanwhile, an access management method according to a second embodiment of the present invention uses access authorization data with a different configuration. The access authorization data includes an access type list generated by use of the data usage type and the business purpose type. The access authorization data used in the access management method according to the second embodiment of the present invention includes the access type list and a registrant condition table, in which elements of a policy setter and elements of the registrants are functionally separated at a higher level than the level in the above-described example embodiment. Moreover, the access authorization data used in this access management method includes the registrant condition table in a format configured to exclude data not accessed from the access authorization data corresponding to the access type and belonging to the access type respectively. Simultaneously, in the access management method according to the second embodiment of the present invention, it is possible to use a so-called compressed registrant condition table in addition to an authorization list where everything is authorized to be accessed and a disapproval list where everything is disapproved to be accessed. It is possible to compress the registrant condition table configured according to the second embodiment of the present invention based on a prescribed rule for a condition agreed by the registrant upon registration. Accordingly, the registrant condition table can achieve high speed while securing a high security level.

That is, according to the present invention, there is provided an access management system for managing access to registrant data including an authorization engine for controlling access to a registrant database storing registrant data having privacy data of a registrant and for controlling access to the registrant database by use of a prescribed privacy policy and condition data designated by the registrant. Here, the authorization engine includes an authorization judgment unit for deciding an access type from an access request received from outside and for controlling reference to the registrant database based on the access request by use of access authorization data to be decided prior to the access request in connection with the access type of the registrant data.

The above-described access management system of the present invention may further include a preliminary calculation unit for calculating the access authorization data in advance, and a storage area for storing the access authorization data. The access authorization data of the present invention may include an identification value for executing access authorization which is generated in advance from the privacy policy and the condition data.

The above-described access authorization data of the present invention may further include a table which is generated in advance by use of the privacy policy and the condition data. Moreover, the table may be written in a format to exclude the access authorization data which are not accessed in response to the above-described access type or the condition data of the registrant. The access authorization data of the present invention may further include an authorization list and a disapproval list.

According to the present invention, there is provided an access management method for managing access to registrant data by use of a computer system. Here, the method includes the steps of: causing an authorization engine to receive an access request from outside; causing the authorization engine to decide an access type from the access request; reading access authorization data to be decided prior to the access request in connection with the access type of the registrant data and comparing the access authorization data with the access type; and controlling reference to a registrant database associated with the access request based on the comparison.

According to the present invention, there is also provided a computer-executable program for causing a computer to execute the above-described access management method. Moreover, according to the present invention, there is provided a computer-readable recording medium storing the above-described computer-executable program.

Moreover, according to the present invention, there is provided an access management system for managing access to registrant data through a network. Here, the access management system includes: a network; a registrant database storing the registrant data containing privacy of a registrant; an application execution unit for issuing access request to the registrant database; an authorization engine connected to the network for controlling the access to the registrant database by receiving the access request from the application unit and using the prescribed privacy policy and condition data designated by the registrant, then controlling the access to the registrant database and a management server for generating access authorization data to be decided prior to the access request in connection with an access type and for causing the authorization engine to use the access authorization data.

According to the present invention, there is provided an access controlling method for controlling a computer to manage access to registrant data through a network. Here, the access management method includes the steps of: causing an authorization engine to use access authorization data calculated in advance through the network; causing the authorization engine to receive an access request from outside to a registrant database storing the registrant data containing privacy of the registrant; deciding an access type upon receipt of the access request from the outside; and controlling the access to the registrant database by comparing the decided access type with the access authorization data decided prior to the access request.

Section A: Outline of access management data to be used in access management according to the present invention

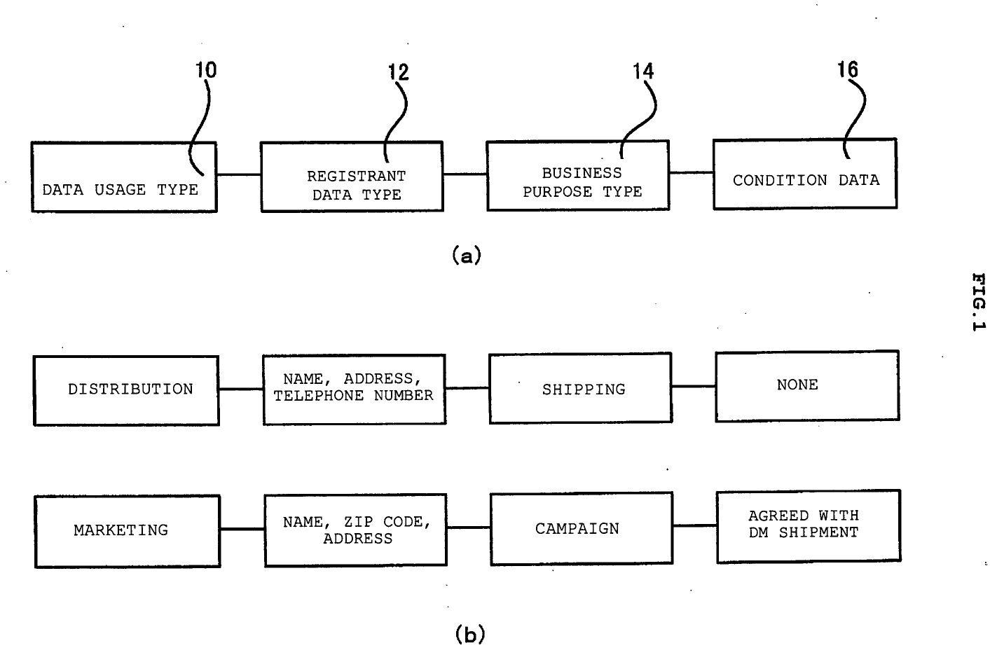

Various techniques have been known as systems for checking appropriateness of a privacy policy according to the present invention. Such techniques are also applicable to the present invention. More specifically, “IBM Corporation, IBM Tivoli Privacy Manager for e-business Planning Guide Version 1.1, July 2002” can be mentioned as a basic technique of this invention and can be incorporated in this invention as reference. FIGS. 1A and 1B show a data configuration which is referred to as a privacy policy in the present invention. As shown in FIG. 1A, the privacy policy is classified into a data usage type 10 of a person in charge who is a data user on a policy setter side, a registrant data type 12, a business purpose type 14, and condition data 16 to be set up by a registrant. More specifically, the data usage type 10 is data for registering a data usage aspect of the person in charge, in such as marketing, distribution, or accounting. Meanwhile, the registrant data type 12 is data registering privacy of the registrant, such as an address, a name, an age, a sex, a telephone number, or an electronic mail address. The business purpose type 14 is more specifically data designating a business necessary for access to the registrant data from the policy setter side, such as distribution, marketing, or accounting. The condition data 16 are data registering a condition agreed and designated by the registrant upon registration as accessible privacy of the registrant.

Configurations of respective data will be described by use of FIG. 1B as an example. As shown in FIG. 1B, if assuming herein that the person in charge on the policy setter side is in charge of processing a distribution business, the person in charge needs the registrant data type “name, address, telephone number” in order to carry out the business. Meanwhile, although various business phases are conceivable for the distribution, the business purpose type of the “distribution” is assumed as “shipping” in FIG. 1B. In the case of the “distribution” as shown in FIG. 1B, the condition data are not required because a condition is not particularly set up on the privacy policy side, for example. Accordingly, the condition data are marked as “none” in the embodiment shown in FIG. 1B. On the contrary, when the data usage type of the person in charge is “marketing”, names, addresses, and zip codes are required for sending DMs. On the other hand, it is not necessary to access other registrant data types. If assuming that business purpose type when carrying out the marketing business described in FIG. 1B is “campaign”, the condition data becomes “consent for sending DMs”.

The access management method of the present invention focuses attention on the fact that these privacy policies can be classified into elements to be decided depending on the policy setter and elements designated by the registrants. Accordingly, access authorization data are configured in advance and a functional portion for executing authorization processing (hereinafter referred to as an authorization engine) stores the access authorization data which are generated in advance. Although various aspects are conceivable as the access authorization data, a example embodiment of the present invention will be described based on the assumption that the access authorization data are generated as a set of an access type list and a registrant condition table.

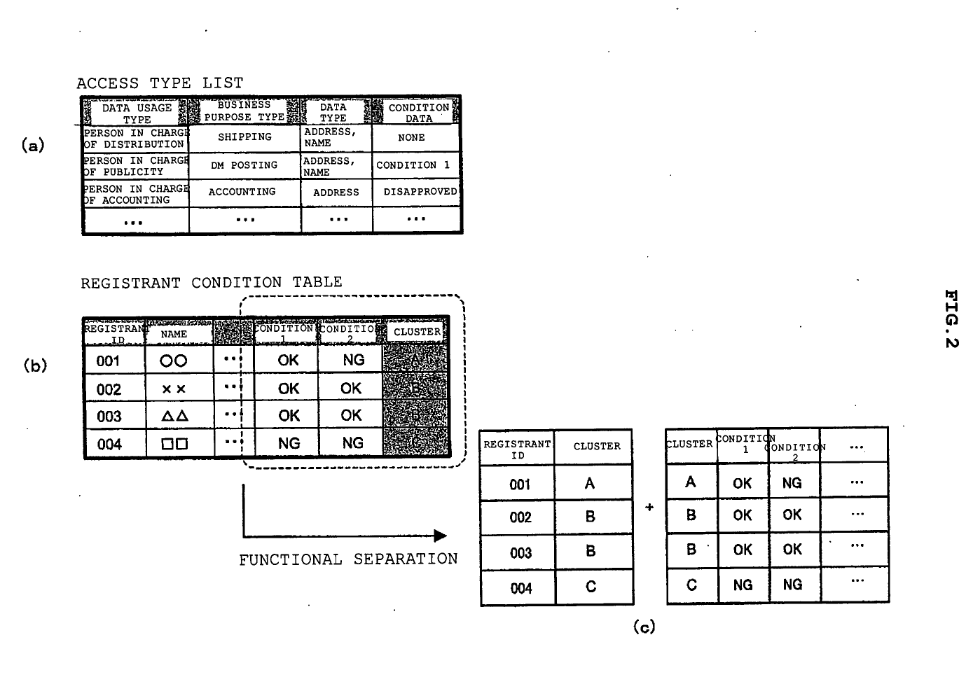

FIGS. 2A to 2C are views showing data structures of the access type list and the registrant condition table constituting the access authorization data to be generated in the access management method according to the example embodiment of the present invention. FIG. 2A shows an aspect of the access type list. As shown in FIG. 2A, the access type list is classified into the business purpose types, the registrant data types, wherein the condition data corresponds to the respective data usage types. Moreover, in the access type list shown in FIG. 2A, access to “addresses, names” and the like are not set up for the registrant data type “distribution”, and the consent condition is not set up for the business purpose type “shipping”. For this reason, “none” is indicated, which means access is enabled in response to only combination of the data usage type and the business purpose type.

Moreover, in the access type list shown in FIG. 2A, when the data usage type is “accounting”, access to the registrant data type “address” is “disapproved” concerning the business purpose type “accounting” in terms of the privacy policy; that is, the access is disapproved. Furthermore, regarding the data usage type “publicity”, access to the registrant data type such as addresses or names is indicated as “condition 1” for “DM posting”. More specifically, the “condition 1” is an instruction to make reference to the consent data of the registrants regarding DM posting and to use return values thereof. The access type list shown in FIG. 2A may be maintained in a normal table format as shown in FIG. 2A, or may be retained as a hash table using “the data usage type [plus] the registrant data type [plus] business purpose type” as a key.

FIG. 2B is a view showing an aspect of the registrant condition table which constitutes the access authorization data of the present invention and is stored in an appropriate storage area included in the access management system of the present invention together with the access type list shown in FIG. 2A. In the registrant condition table shown in FIG. 2B, registrant identifiers (hereinafter referred to as registrant IDs given to each registrant in the registrant database, a list of the condition data indicating necessities of setting or consent at least by the registrants, and cluster identification values generated from the condition data by use of prescribed logic such as logical addition or logical multiplication are registered for each registrant ID to constitute records. In the particular aspect shown in FIG. 2B, the registrant condition table may include appropriate registrant data type other than the above-described database.

The condition data to be registered in the registrant condition table shown in FIG. 2B are not particularly limited in the present invention. However, the condition data may include data concerning agreement or disagreement to the consent conditions in the privacy policies.set by the policy setter, such as reference to names, addresses, telephone numbers, facsimile numbers, ages, sexes, electronic mail addresses, interested fields or preferences. Moreover, the condition data may further include a condition such as age limit, which can be arbitrarily set by the policy setter. The registrant condition table shown in FIG. 2B is provided with the cluster identification values A to C which are given to each registrant. The present invention may further adopt other cluster identification values as appropriate. According to the present invention, the cluster value included in the registrant condition table executes access authorization if only the corresponding cluster identification value is discovered.

The registrant condition table shown in FIG. 2B can be entirely calculated in advance. However, as will be described later, it is also possible to use an aspect in which a registration area is secured in advance; a logic judgment of the condition data is carried out at runtime; and the cluster identification values are judged, to add records in the registration area. In addition, FIG. 2C shows an aspect in which the function of the registrant condition table of the present invention shown in FIG. 2B is separated into a consent pattern; a table storing the cluster identification values corresponding to the consent pattern using the cluster values as keys; and a table constituted by the registrant IDs and the cluster identification values. In the aspect shown in FIG. 2C, it is also possible to constitute the access authorization data having the similar function to the registrant condition table shown in FIG. 2B.

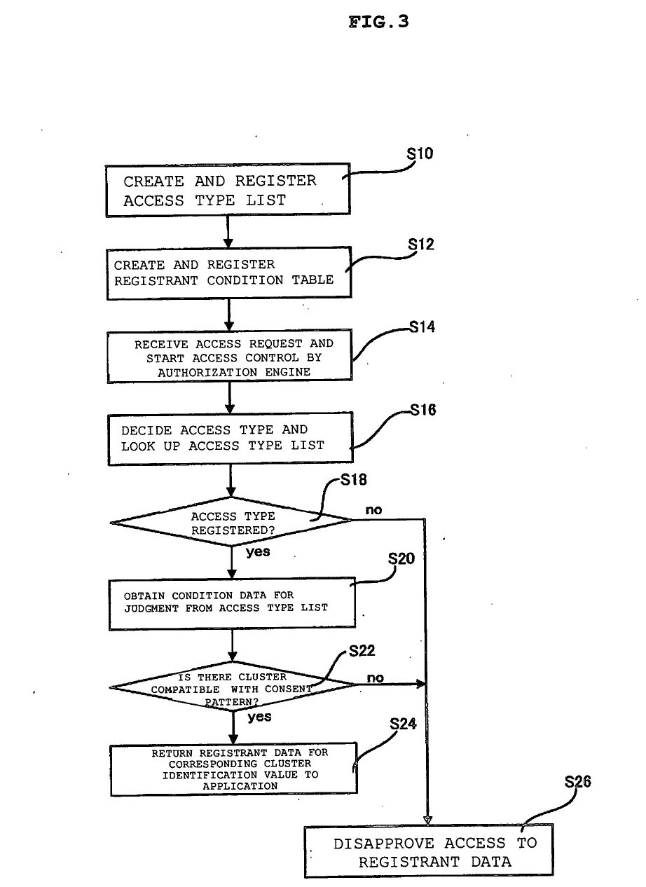

FIG. 3 shows a flowchart of the access management method according to the example embodiment of the present invention. In the access management method according to the example embodiment of the present invention, in Step S10, the privacy policies are read out of the privacy policy database and the access type list is generated by registering the data usage types, the authorizable registrant data types, the business purpose types, and the condition data for reference. In Step S12, the registrant database is accessed to read out the registrant data types and the corresponding condition data thereto, and then the registrant condition table is generated so as to include the cluster identification values depending on the consent conditions of the registrants in response to condition logic to be applied to the condition data.

In Step S14, the authorization engine receives the access request from the application and starts access control to the registrant database. In Step S16, the data usage type, the registrant data type, and the business purpose type which are included in the access request, and requested by the person in charge at the policy setter, are read out and the access type list is searched. In Step S18, as a consequence of the research, whether or not the access type is authorized is judged. When the access type is included in the access type list (yes), the process continues to Step S20 to obtain the condition data or a set of the condition data in the registrant condition table to be used for judgment. Meanwhile, when it is judged in Step S18 that the access type is not authorized (no), the process is branched off to Step S26 to disapprove the access request from the application.

In Step S22, it is judged that whether or not the obtained condition data or the set of the obtained condition data coincide with condition data or a set of condition data when registering the cluster identification values in advance, and the corresponding cluster identification value is obtained. When the cluster identification values are obtained in the course of comparison in Step S22, the registrant condition table is referenced in Step S24 and regarding the registrant IDs corresponding to the cluster identification values, the registrant data are obtained from the registrant database. Then, the registrant data are returned to the application.

Meanwhile, when the corresponding cluster identification value is not found (no) in the judgment in Step S22, then the process is branched off to Step S26 in this embodiment of this invention designed to execute the preliminary calculation, which is explained in FIG. 3, and the access request to the registrant data is disapproved.

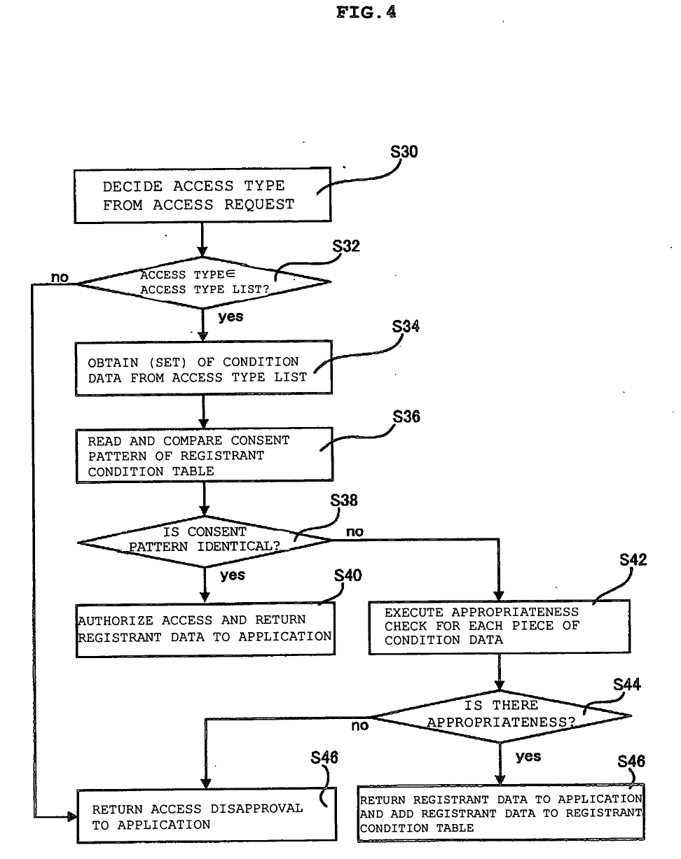

FIG. 4 shows a modified example of the access management method shown in FIG. 3. The modified example shown in FIG. 4 adopts the configuration in which the authorization engine dynamically updates the registrant condition table at runtime after generation of the access type list. In the modified example shown in FIG. 4, an access request from an outside application execution unit is received and an access type is obtained in Step S30. In Step S32, whether or not the obtained access type is included in the access type list is judged. In the judgment of Step S32, when the access type is registered already (yes), the condition data or a set of the condition data are obtained in Step S34. Then, in Step S36, the registrant condition table is read out to obtain consent patterns of the condition data, and whether or not an identical consent pattern is registered therein is judged. In the judgment of Step S36, if the identical consent pattern is found out (yes), then access to the registrant data is authorized in Step S38 to obtain the corresponding registrant data, and a result is returned to the application.

Meanwhile, if it is judged that no appropriateness is found in the access type (no) in Step S32, then the process is branched off to Step S46 and access disapproval is notified to the application.

Meanwhile, if the identical consent pattern is not found (no) in Step S36, the process continues to Step S42 and an appropriateness check as similar to the prior art for the condition data or the set of the condition data obtained in Step S34 is executed by applying the condition logic of the privacy policy at runtime. In Step S44, a value obtained as a result of the appropriateness check is judged. When there is appropriateness (yes), access to the registrant database is authorized in Step S46, whereby the corresponding registrant data are obtained and the results are returned to the application. Simultaneously, in Step S48, a new cluster value such as “D” is obtained. Then data similar to the data shown in FIG. 2B are written in a blank record, which is provided in the registrant condition table in advance, to be capable of corresponding with a future access request at high speed.

Meanwhile, when it is judged that there is no appropriateness in Step S44 (no), the process continues to Step S46 and access disapproval is returned to the application. In the modified example of the present invention shown in FIG. 4, it is possible to write the registrant condition table or the access type list in a recording medium such as a hard disk at anytime. However, in the access management method according to the example embodiment of the present invention, it is also possible to read the access authorization data such as the access type list and the registrant condition table into a cache memory together with the blank record at runtime so as to perform reading and writing access at high speed.

Moreover, in another embodiment of the present invention, it is also possible to adopt a configuration in which the processes from Step S42 to Step S48 are applied to the access type list to achieve similar processing so that the access type list is updated at runtime.

The above-described modified example of the access management method of the present invention adopts the constitution to register the access authorization data into a high-speed memory as clusters and to execute addition and updating at runtime. Therefore, a new appropriateness check is executed with respect to an unregistered access type or a consent pattern of the condition data. However, the access management method according to the modified example has the following advantages that: (i) it is not necessary to execute processing for configuring the access type list or the registrant condition table in advance; (ii) it is not necessary to perform preliminary calculation for the appropriateness check for the condition data which are not judged at all or for an access request having considerably low utilization; and (iii) the access management method can deal with updating of the registrant data without adding another process to the system for executing the appropriateness check.

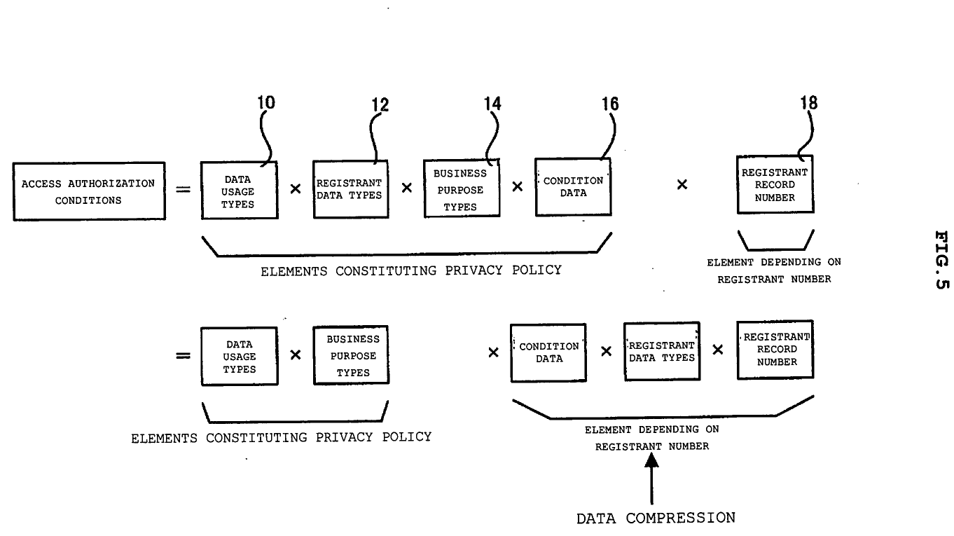

FIG. 5 is shows a restructuring example for the privacy policy to generate the access authorization data used in the access management method according to the second embodiment of the present invention. In the restructuring example for the privacy policy shown in FIG. 5, restructuring is performed to level up the separation between the elements on the policy setter's side and the elements on the registrant's side than the restructuring example shown in FIG. 1. In FIG. 5, access authorization conditions obtained from the privacy policy are restructured as described below. That is, only the policy setter sets and manages the data usage type 10 and the business purpose type 14 in principle. Meanwhile, the condition data 16, the registrant data type 12 and a record number 18 are data which can be modified depending on the registrant. For this reason, the access authorization data used in the access management method according to the second embodiment of the present invention adopts the configuration in which the access type list is generated by use of the data usage type 10 and the business purpose type 14, and further the registrant condition table is generated by use of the condition data 16, the registrant data type 12, and the record number 18, and the access type list and the registrant condition data table are calculated in advance as the access authorization data and are stored in a prescribed storage area.

That is, in the access management method of the present invention shown in FIG. 5, the registrant condition table corresponding to the access type and further including the condition data having the same numbers of condition data with the record numbers of the registrants is generated and registered in advance. In the access management method using the access authorization data shown in FIG. 5, when the access type is designated, it is satisfactory if only a value of the relevant condition data in the corresponding registrant condition table is referenced. Therefore, this access management method is common to the access management method according to the example embodiment of the present invention in terms of capability of accelerating the appropriateness check compared with the conventional access management method, in that it is not necessary to check the appropriateness of the condition data while reading the privacy policy data at runtime and applying the condition logic. Moreover, the access management method shown in FIG. 5 can also adopt a modified example where the access authorization data is dynamically added and updated at runtime.

On the other hand, when executing the access management method using the access authorization data shown in FIG. 5, it is necessary to store the registrant condition table, which is calculated in advance in terms of the consent patterns of all the access types, into the storage area. To achieve this, an enormous storage area (such as a memory or a database) is required in many cases corresponding to the number of the registrants. If the preliminary calculation is executed for all the access types and the consent patterns based on the assumption that the privacy policy includes the elements shown in FIG. 1, then it is theoretically necessary to execute the preliminary calculation using the condition data for the following number of times and store relevant results in the storage area:

$$\begin{matrix}[ Formula 1 ] & \\ The number of access types = & ( Formula 1 ) \\ the number of kinds of the “ data usage types ” & \\ [ multiplied by ] & \\ the number of kinds of the “ registrant data types ” & \\ [ multiplied by ] & \\ the number of kinds of the “ business purpose types ” & \\ [ multiplied by ] & \\ the number of kinds of the “ condition data ” & \\ [ multiplied by ] & \\ the record number of a client database & \end{matrix}$$

Sufficient access management is achieved in the above-described processes only if hardware resources such as a storage capacity or processing speed used in an access management system are sufficient for storing the above-described data. However, according to the present invention, it is possible to impart a wide range of appropriateness to the performances of the hardware resources by compressing the registrant condition table corresponding to the access types as will be described later. Now, the above-mentioned compression processing for the access authorization data in the present invention will be described. The term “compression processing for the access authorization data” in the present invention refers to processing for deleting the registrant condition data which are not accessed at least by judging from the privacy policy when accessed and for generating a “disapproval list” at least indicating the deleted registrant condition data.

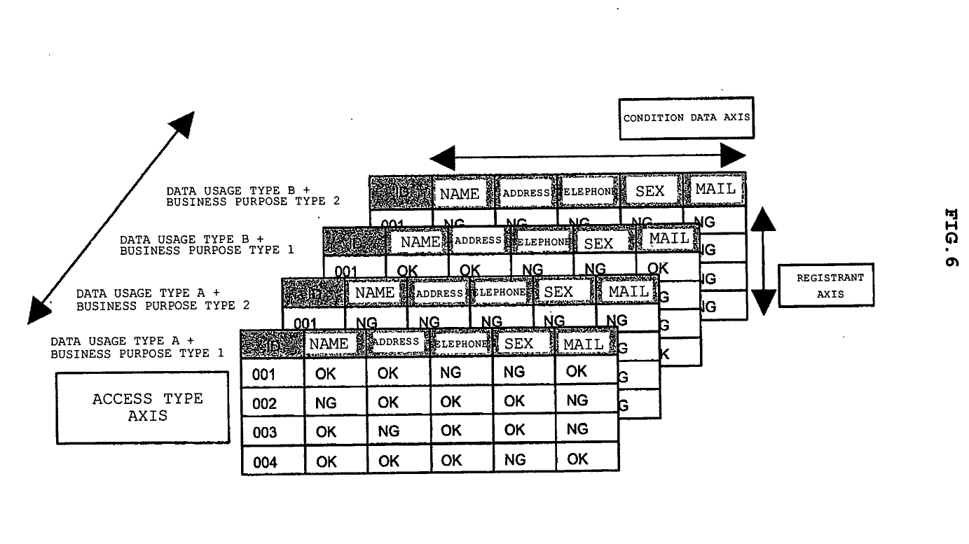

FIG. 6 shows reference axes applied when performing the compression processing for the registrant condition table contained in the access authorization data which are usable in the access management method of the present invention. In the present invention, the registrant condition table is regarded as a three-dimensional constitution having three axes of an access type axis corresponding to the records of the access type list, a condition data axis corresponding to the number of the condition data, and a registrant axis corresponding to the number of the registrants. In the present invention, these axes are used as the reference axes in the compression processing. When the privacy policy shown in FIGS. 2A to 2C is examined, it is found that the appropriateness check can be executed with judgment of the access type only, without referring to the registrant condition table or the registrant condition data, which are not usable at all or not necessary to use.

Specifically, when the data usage type is distribution and the business purpose type is accounting, then the access is judged to be disapproved, based on the setting of the privacy policy without making reference to the registrant condition table or executing the appropriateness check for each piece of the.condition data. Meanwhile, when the data usage type is distribution and the business purpose type is shipping, then there is a case where access authorization is obvious at the point of policy setting with respect to the addresses, the names, and the telephone numbers. Incidentally, as for the condition data, it is possible to execute the compression processing along with the respective corresponding reference axes by focusing on the existence of a certain classification in the registrant condition data, such as a classification pattern for each condition data where access by telephone is rejected but access by electronic mail, facsimile or DM is accepted, or a classification pattern depending on the registrants which tends to reject unnecessary use of the sexes and the ages. In the present invention, the above-described cases are referenced as the processing for compression along the access type axis, compression along the condition type axis, and compression along the registrant axis. These compression processes will be described in detail hereafter.

(Compression along the Access Type Axis)

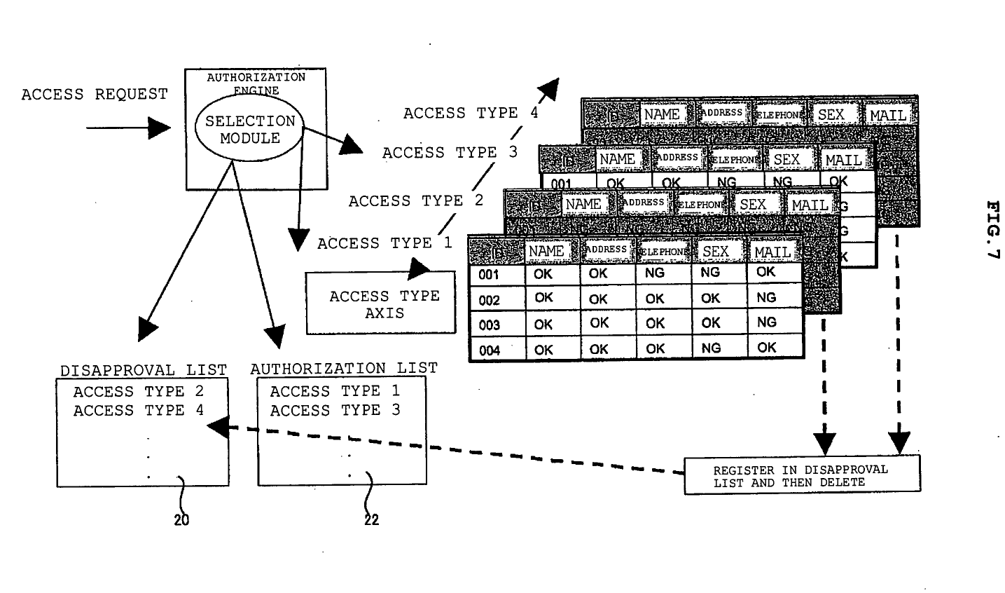

In particular, the access type axis in the present invention is an axis corresponding to the records on the access type list. In the compression processing for this axis, the processing is carried out by classifying the sets of the generated registrant condition table into the cases where no access authorization is granted regardless of executing the appropriateness check for the access types and the cases where all kinds of access are authorized, and then by registering those cases into an “authorization list” and the “disapproval list” in advance. FIG. 7 is a view schematically showing this compression processing. As shown in FIG. 7, the registrant condition tables are created for an access type 1 to an access type n which are given as a multiplication of the number of the data usage types and the number of the business purpose types. Among them, if assuming that the access type 2 represents the data usage type of distribution and also the business purpose type of accounting, for example, the result of the appropriateness check will be always disapproval. Accordingly, it is unnecessary to store the access type 2 into the storage area as a registrant condition table. Therefore, the compression processing is performed by deleting that table.

According to the present invention, the compression processing is performed by deleting unnecessary registrant condition tables and generating the disapproval list corresponding to the deleted tables instead. In the embodiment described in FIG. 7, the access type 2 described above and the access type 4 are added to the disapproval list 20. Simultaneously, in FIG. 7, the access type 1 and the access type 3 can be classified as the access types, all of which are authorized without sequential judgment of the condition data. Accordingly, in FIG. 7, the access type 1 and the access type 3 are registered in the authorization list 22. For example, the access type 1 represents the data usage type of “distribution” and the business purpose type of “shipping”. In this case, the privacy policy shows that all the registrant IDs have agreed with access to the addresses and the names which are required for shipping. Accordingly, it is not necessary to execute the appropriateness check when the registrant data contained in the access request are just the addresses and the names. For this reason, it is possible to add the access type 1 to the authorization list.

Moreover, FIG. 7 shows the processing to be executed in the access management method of the present invention, in which the appropriate check is executed comprising the steps of deciding the access type by use of the authorization engine when the access request arises, selecting the table by use of a selection module, and making reference to the disapproval list and the authorization list and thereby executing the appropriateness check.

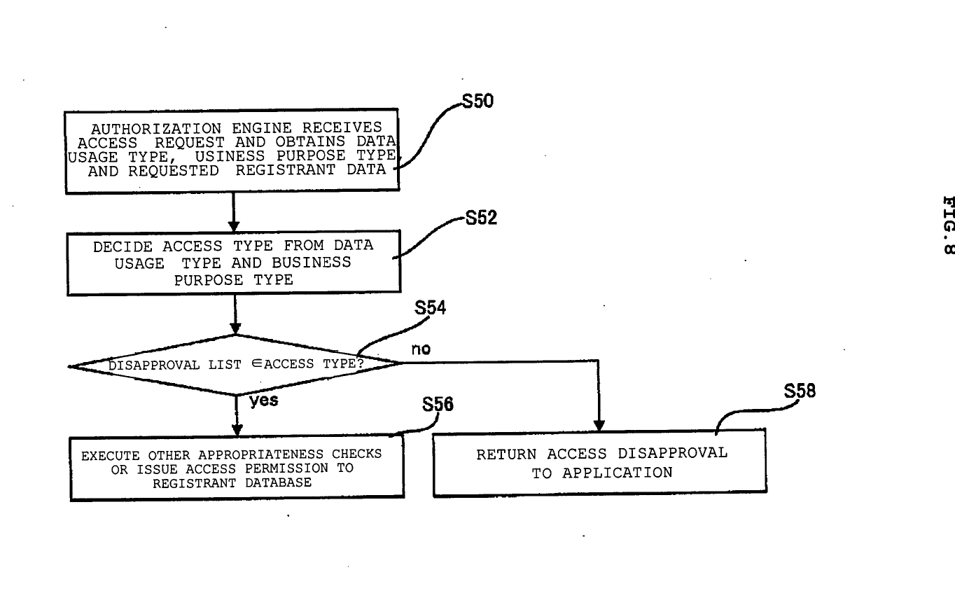

FIG. 8 is a flowchart showing the processing to be executed by the authorization engine when executing the access management method of the present invention by use of the data compression shown in FIG. 7. In Step S50, the authorization engine of the present invention receives an access request from an application configured as another software module separately from the authorization engine, and executes data reading of the data usage type, the business purpose type and the requested registrant data. In Step S52, the access type is decided based on the data usage type and the business purpose type which are read out in the previous step. In Step S54, the disapproval list 20 is firstly accessed to execute comparison of the obtained access type so as to judge whether or not the decided access type is registered in the disapproval list 20. In Step S54, when the decided access type is registered in the disapproval list 20 (yes), it is not necessary to execute the subsequent appropriateness check. Hence, access disapproval is issued to the application.

Meanwhile, by the judgment of Step S54, when it is found that the decided access type is not registered in the disapproval list in Step S54 (no), access will be authorized depending on the condition or without conditions. Accordingly, the process continues to Step S56 for executing the appropriateness check. On the contrary, when the decided access type is registered in the disapproval list in Step S54, the process continues to Step S58 and the access disapproval is returned to the application and the appropriateness check is terminated at that point. Moreover, in another embodiment of the access management method according to the present invention, it is also possible to adopt the processing in which the authorization list 22 is read out first and the disapproval list 20 is referenced at a time when the obtained access type is judged not to be registered in the authorization list 22.

(Compression Processing along the Condition Data Axis)

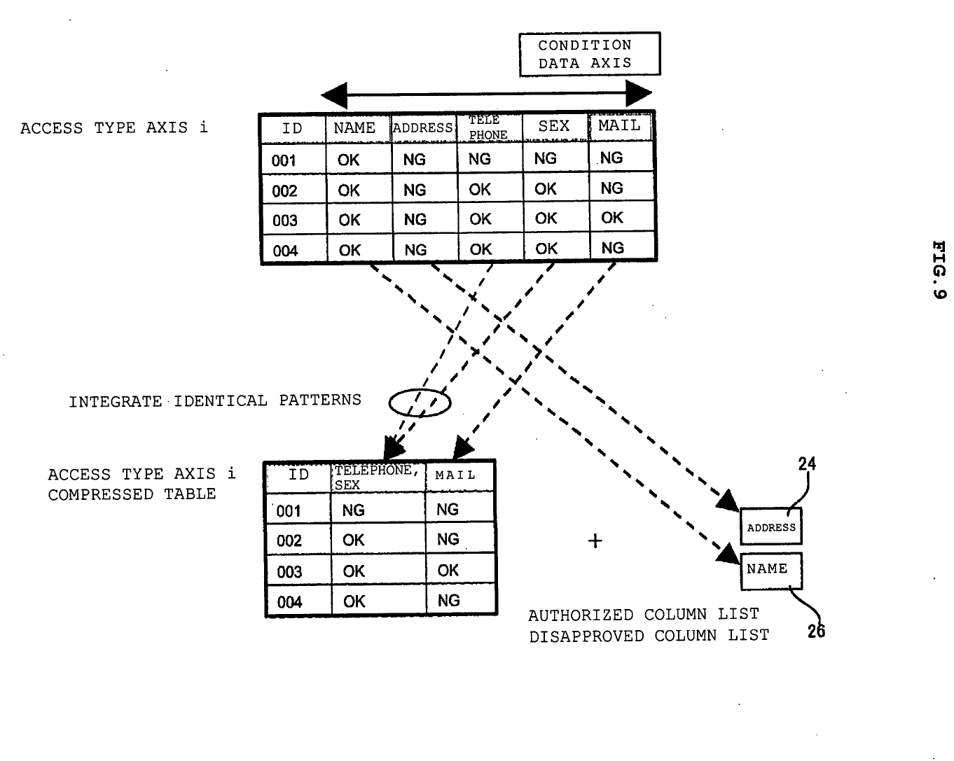

FIG. 9 is a schematic drawing showing the compression processing along the condition data axis, which is another embodiment of a data compression method of the. present invention. As shown in FIG. 9, in a registrant condition table corresponding an access type designated by an access type axis i, it is assumed that all the registrants agree with access to the names but do not agree with access to the addresses of a relevant business purpose type. In the compression processing along the condition data axis of the present invention, an authorization list 24 and a disapproval list 26 by the column are prepared and stored in an appropriate storage area. Simultaneously, the columns which are registered in the authorization 24 and the disapproval list 26 are deleted from the original registrant condition table. Moreover, the condition data for different columns are examined to judge as to whether or not all the registrants register authorization or disapproval in the same pattern. When all the registrants agree with the authorization in the same pattern, then the columns are integrated and indices are allocated to the integrated columns for reference to the corresponding condition data. After the above-described processes are executed, the access authorization data of the present invention are finally formed into a group of “the access type list, the compressed registrant condition table, the authorization list, and the disapproval list” and are stored in the storage area in a format usable by the authorization engine.

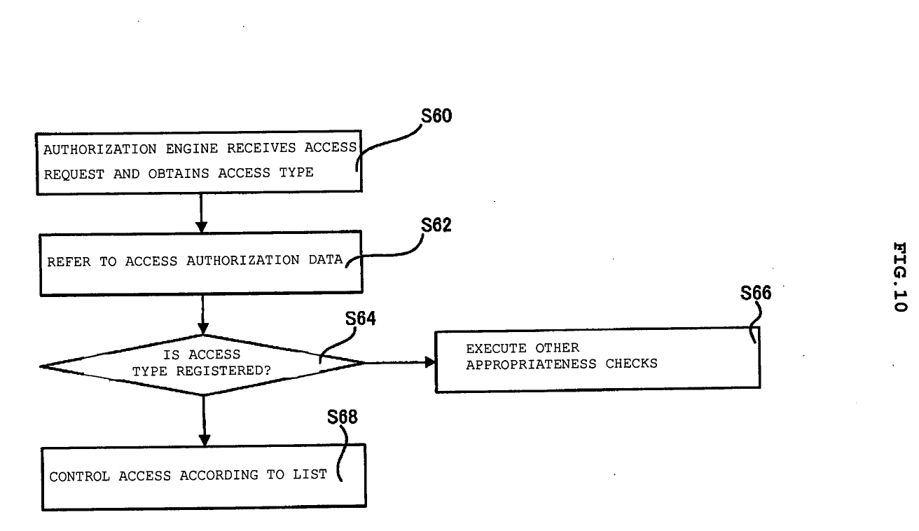

FIG. 10 is a flowchart showing the processing to be executed by the authorization engine when using the access authorization data after execution of the compression processing along the condition data axis. According to the processing shown in FIG. 10, in Step S60, an access request is received from an application configured as an external function module, then the data usage type, the business purpose type and the requested registrant data are obtained and the access type is decided. In Step 62, the access authorization data is referenced corresponding to the obtained access type, and the authorization list or the disapproval list is referenced. In Step S64, whether or not the access type corresponding to the requested registrant data is registered in each list is judged. When the corresponding access type is registered in the authorization list or the disapproval list (yes), the process continues to Step S66 and access is controlled in accordance with the corresponding list. On the contrary, when the corresponding access type is not found in the authorization list or the disapproval list in Step S64, the process continues to Step S68 so that other appropriateness checks are executed.

(Compression Processing along the Registrant Axis)

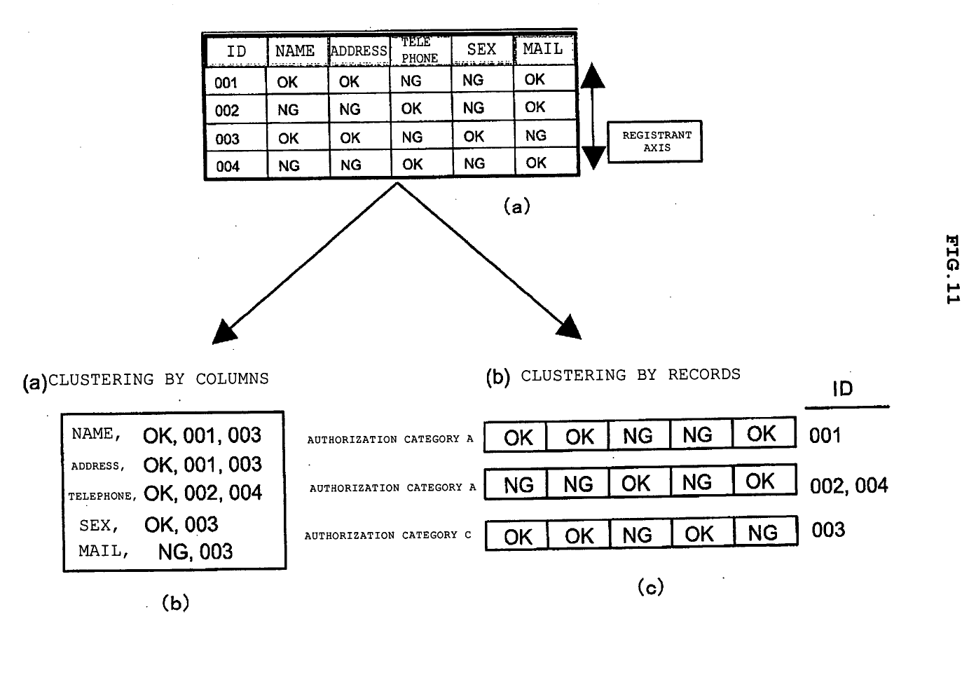

FIGS. 11A to 11C describe an outline of the data compression processing along the registrant axis used in the present invention. In the privacy policy set by the policy setter, there may be a case where identical authorization judgment having a certain classification for the identical data types is given even in the case of different registrants. In this case, it is possible to compress the registrant condition table by compressing the registrants for each classification of the condition data. Specifically, as shown in FIG. 11A, for example, the registrants having the registrant ID 002 and the registrant ID 004 have the identical consent condition data from the name to the mail and thereby collectively constitute a classification.

Meanwhile, it is also possible to carry out similar processing in column units. FIG. 11B shows an authorization/disapproval list of the registrants in column units, and FIG. 11C shows a list after the data compression executed by configuring the authorization/disapproval list for each classification based on the records. In the data compression along the registrant axis shown in FIGS. 11A to 11C, all authorization/disapproval data of the registrants are registered in each list. Accordingly, the authorization engine looks up in any of the list, then executes the authorization judgment. The judgment processing by the authorization engine in this embodiment can be executed in a substantially similar manner to the example embodiment of the present invention which utilizes the access authorization data.

Moreover, in the access management method of this embodiment as well, it is possible to adopt the configuration in which the access authorization data is stored in a high-speed cache memory together with a blank records and sequentially added at runtime.

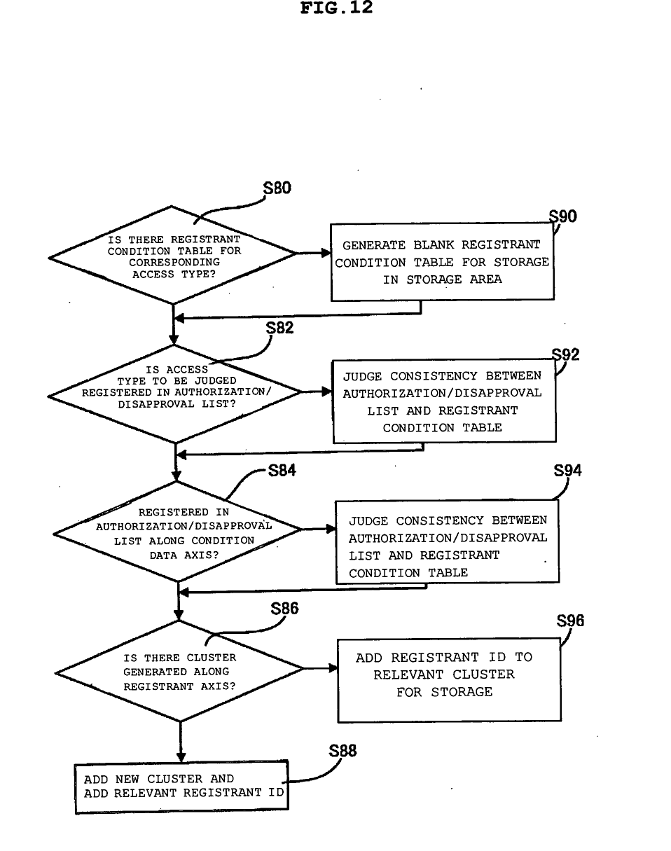

FIG. 12 is a flowchart showing the processing for adding and updating the access authorization data at runtime, which can be executed when using the access authorization data of the second embodiment of this invention. The processing for updating the access authorization data at runtime shown in FIG. 12 is started from Step S80, in which whether or not there is a registrant condition table corresponding to a certain access type is judged. When the corresponding registrant condition table exists in the judgment of Step S80 (yes), the process continues to Step S82 and whether or not the access type to be judged is registered in the authorization/disapproval lists.

In the judgment of Step S82, when the access type to be judged is not included in the authorization/disapproval list (no), the process continues to Step S84 and whether or not the access type is registered in the authorization/disapproval list generated along the condition data axis. When the access type does not exist in the authorization/disapproval list in the judgment of Step S86 (no), in Step S86, whether or not a cluster to be generated along the registrant axis exists is judged. When the corresponding access type does not exist either in the judgment of Step S86 (no), the privacy policy data are read out and the appropriateness check is executed in Step S86. Then, a result of the check and the registrant ID are added to the blank registrant condition table, and the process is completed. On the contrary, when the corresponding registrant condition table does not exist in the judgment in Step S80 (no), then a corresponding registrant condition table is generated in blank and stored in the storage area. Then, the process is branched off to Step S82 and the next authorization judgment is executed.

Meanwhile, when it is judged that the access type belongs to the authorization/disapproval list in the judgment of Step S82 (yes), the process continues to Step S92 and consistency between the authorization/disapproval list and the registrant condition table is checked, and then the process is branched off to the judgment of Step S84. In the present invention, the processing for checking the consistency refers to the processing including the steps of judging whether or not the access authorization obtained by use of the authorization/disapproval list conflicts with the result given by the registrant condition table, deleting the access authorization generated by the authorization/disapproval list in case of a conflict, and modifying the access authorization into proper access authorization and storing the proper access authorization. Moreover, when it is judged that the access type belongs to the authorization/disapproval list in the judgment of Step S84 (yes), the process continues to Step S94 where consistency between the authorization/disapproval list and the registrant condition table is checked and the process is further branched off to the judgment of Step S86. Furthermore, when it is judged that there is a cluster of the corresponding access type in the judgment of Step S86 (yes), the corresponding registrant ID is added by use of a result of execution of the appropriateness check for the cluster, and the process is completed.

It is not always necessary to select any one mode of the compression processing described above. It is possible to execute the data compression in combination of a plurality of the above-described modes as needed. For example, it is possible to execute the compression processing along the condition data axis after executing the compression processing along with the access type axis so as to perform the compression processing along the condition axis for the columns which are not included in the authorization list or the disapproval list. Thereafter, the compression processing is executed along the registrant axis for each record. In this way, it is possible to considerably reduce the overhead for the appropriateness checks to be executed by the authorization engine after receiving the access request from the application.

Section B: Implementation of the access management method of the present invention

The access management system of the present invention is configured as a computer-executable program. The computer-executable program recorded in a computer-readable recording medium or a transmission medium is installed in a computer system so as to cause the computer to achieve the respective functions described above. Now, processing to be performed will be explained when the access management system of the present invention is implemented in the computer system. Hereafter, the most basic access management system is assumed for explanation. However, it is to be noted that similar functions can be configured over appropriate constituents even in the access management method or access management system mutually connected via a network respectively.

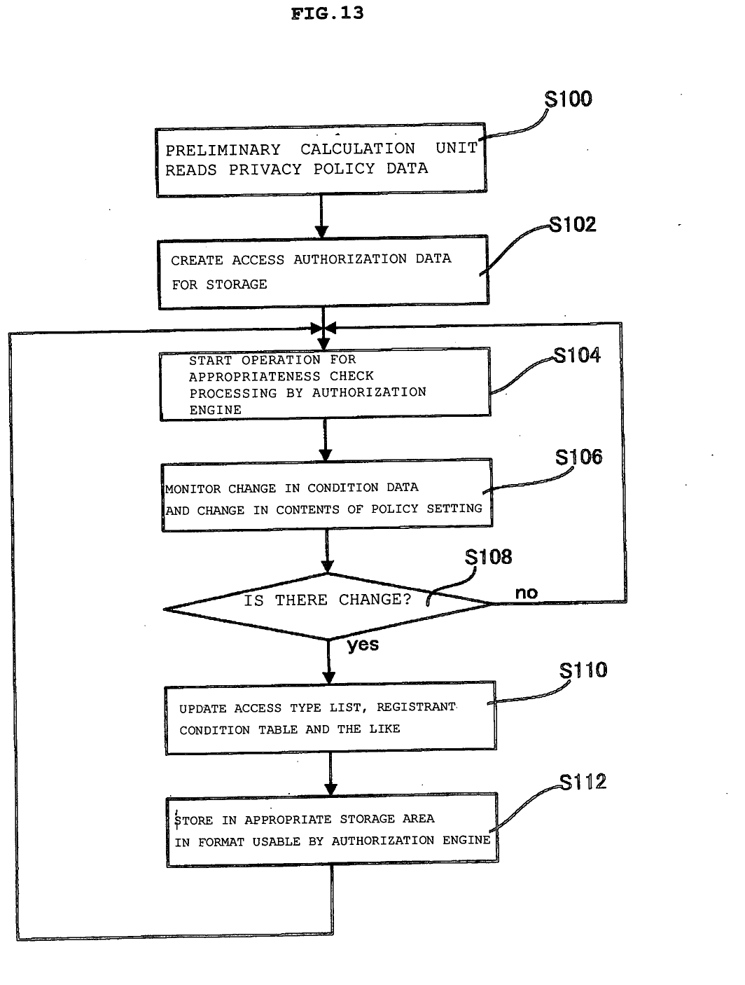

FIG. 13 shows primary processing of the access management method of the present invention prior to starting the process. This processing can be executed by a preliminary calculation unit configured in any of computers in the system. In the primary processing shown in FIG. 13, in Step S100, the preliminary calculation unit is caused to read the privacy policy data which are set up by the policy setter. It is also possible to execute such a storing method by reading the privacy policy stored in any of storage units in the system. Alternatively, the person in charge at the policy setter can perform input and storage according to an appropriate method.

In Step S102, either generation of the cluster value or the compression processing is executed in response to the format of the access authorization data to be used, whereby the above-described access authorization data including the access type list and the registrant condition table are created and stored in the storage area. As another embodiment, it is also possible to store the access type list, the registrant condition table, the condition logic, and the selection logic into a memory area which the authorization engine and a creation unit can share. As further another embodiment where the authorization engine and the creation unit are remotely connected to each other through a network, it is possible to transmit the access type list, the registrant condition table, the condition logic, the selection logic, and the like are transferred to and stored in the authorization engine, or it is also possible for the authorization engine to make reference to the access type list, the registrant condition table, the condition logic, the selection logic, and the like stored in the creation unit and to perform the processing.

In Step S104, the authorization engine is caused to start the processing for the appropriateness checks and to manage access to the registrant database in response to the access request from the application. In Step S106, a monitoring unit causes the authorization engine to continuously or sequentially monitor as to whether there is a change in the condition type such as consent by the registrant or a change in the contents of policies on the policy setter's side. Results of judgment in Step S106 are sent to Step S108. When it is judged that any of the data is updated in Step S108 (yes), the process continues to Step S110 where the portion in the access type list, the registrant condition table, the condition logic, the selection logic, or the like to be changed is specified, and the preliminary calculation unit executes recalculation.

In Step S112, the recalculated portion out of the access type list, the registrant condition table, the condition logic, the selection logic, and the like is stored in an appropriate storage area as usable by the authorization engine. Then the process returns to Step S104 and the processing by the access management system is executed continuously. Meanwhile, when it is judged that there are no updates as a result of the judgment of Step S108 (no), the existing access type list, the registrant condition table, the condition logic, the selection logic, and the like are usable directly. Accordingly, the process returns to Step S104 without updating the access authorization data and the processing by the access management system is executed.

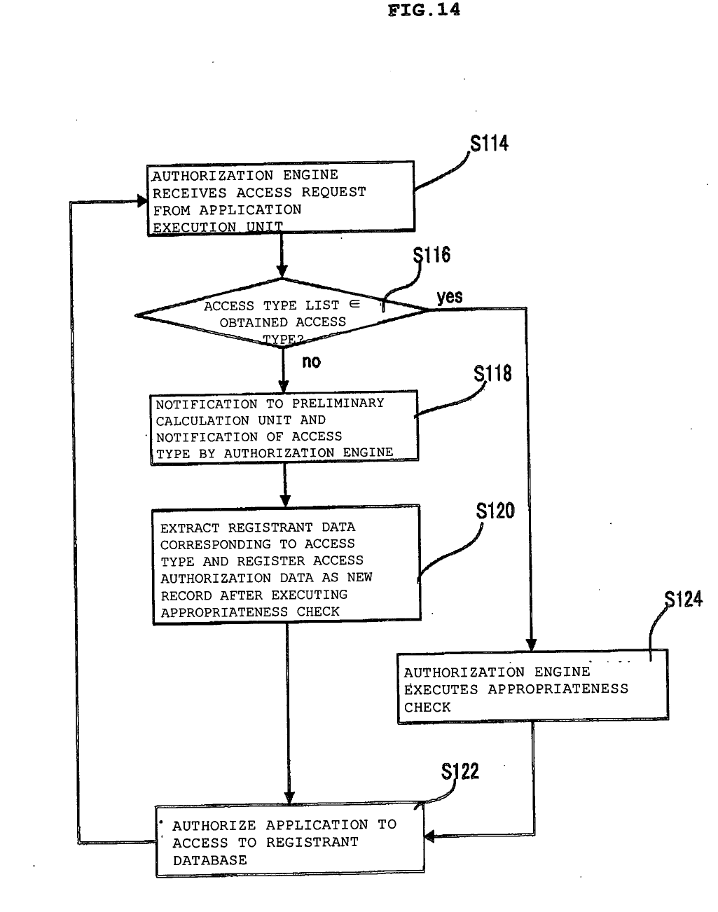

FIG. 14 shows the processing by the access management method of another embodiment where the registrant condition table is dynamically added instead of being created in advance. In the embodiment shown in FIG. 14, the authorization engine receives the access request to the registrant data from the application and thereby obtains the access type in Step S114. In Step S116, the authorization engine searches the access type list and the registrant condition table, and judges whether or not the obtained access type is found in the access authorization data. When no data corresponding to the registrant condition table are found in the judgment of Step S116 (no), the process continues to Step S118 and the authorization engine notifies the preliminary calculation unit of the absence of a result corresponding to the access authorization and of the requested access type. In Step S120, the preliminary calculation unit accesses the registrant database and extracts the registrants corresponding to the access type. Then, the preliminary calculation unit executes the appropriateness checks by comparing the registrant data with the private policy to generate the cluster identification value. Subsequently, the preliminary calculation unit registers the cluster identification value as a new record in the registrant condition table. In Step S122, the creation unit returns the whole part of or the updated part of the created access authorization data to the authorization engine, and causes the authorization engine to execute the appropriateness checks.

Meanwhile, when the data corresponding to the registrant condition table are found in the judgment of Step S116, it is possible to complete the appropriate checks for the access request which is evaluated at that point by means of only making reference to the cluster identification value obtained already by executing the appropriateness checks. In the embodiment shown in FIG. 14, the appropriateness checks of the condition data are performed at runtime. Accordingly, although it takes more time to receive the results on the application side as compared to the embodiment described in FIG. 14, it is possible to impart the same efficiency as that described in FIG. 14 when the registrant condition table is once configured. Moreover, in order to accelerate this processing, it is also possible to construct the registrant condition table sequentially in the cache memory.

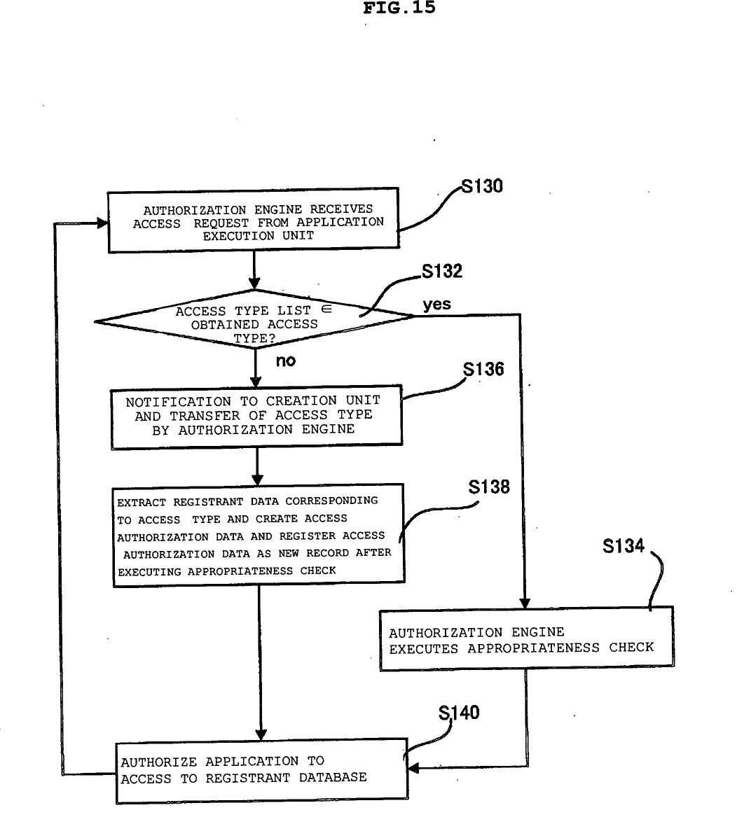

FIG. 15 is a view showing an aspect of the processing for dynamically adding the record when creating the registrant condition table for each access type in the access management method according to the second embodiment of the present invention. In FIG. 15, the authorization engine received the access request to the registrant data from the application to thereby decide the access type in Step S130. In Step S132, the access type list is referenced while using the decided access type and the requested registrant data as keys, and whether or not the decided access type exists in the access type list is judged. When the access type list is found in the judgment of Step S132 (yes), the process continues to Step S134 and judgment for access authorization is executed by use of the corresponding registrant condition table. Then access control to the registrant database is executed in Step S140 based on a result thereof. Thereafter, the process returns to Step S130 for standing by for a subsequent access request.

On the contrary, when the access type judged at that moment is not found in the access type list in the judgment of Step S132 (no), the process continues to Step S136 and the authorization engine passes the notification of absence of the access type and the relevant access type to the creation unit. In Step S138, the preliminary calculation unit executes the appropriateness check by use of the privacy policy data and creates a new record for the access authorization data together with a result of the appropriateness check. Then, the preliminary calculation unit stores the access authorization data in the storage area as a format usable by an evaluation engine. In Step S140, the evaluation engine executes the appropriateness check by use of the newly obtained record, and a result thereof is returned to the application.

Section C: The access management system of the present invention

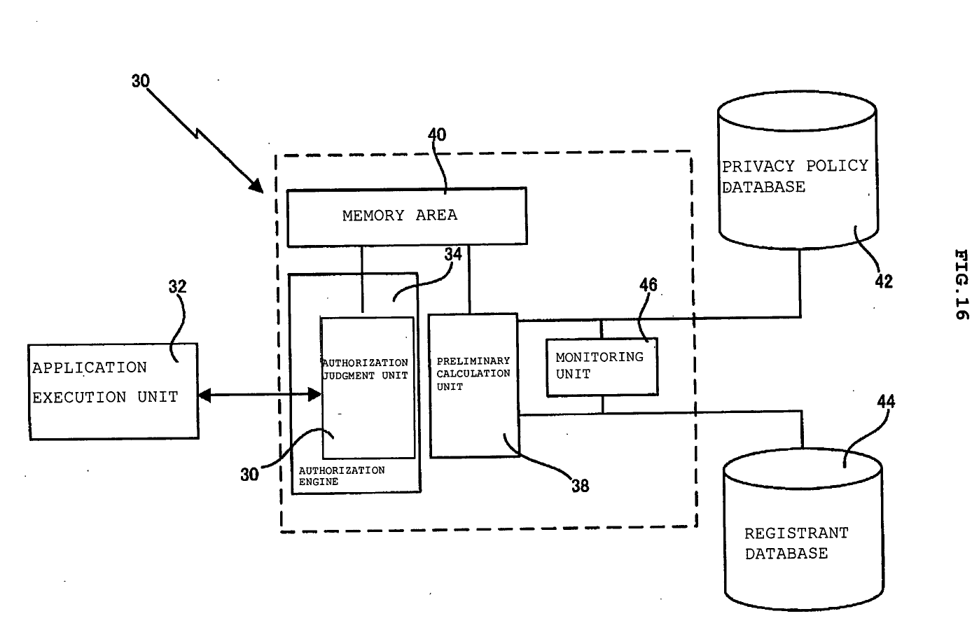

FIG. 16 is a schematic functional block diagram showing the access management system according to the present invention where the access management method of the present invention is implemented. As shown in FIG. 16, an access management system 30 of the present invention includes an authorization engine 34 for receiving an access request from an application execution unit 32 and for executing processing, a preliminary calculation unit 38, and a storage area 40. The authorization engine 34 includes an authorization judgment unit 36 for processing access authorization judgment. The application execution unit 32 receives an input from the person in charge and issues the access request to the authorization engine 34 by use of an SQL sentence or the like. Moreover, the application execution unit 32 also executes processing for receiving a result from the authorization engine and returning the result to the person in charge. The application execution unit 32 is configured as capable of carrying out prescribed operations by causing a computer to execute either specific or general operation software related to the operation required by the policy setter.

The authorization engine 34 receives the access request and reads data such as a data usage type, a business purpose type, or requested registrant data contained in the access request. Then, the authorization engine 34 decides a requested access type from the data thus read out, and stores the access type in a memory area 40 properly constituted including a hard disk, a high-speed access memory (a cache memory). Meanwhile, the preliminary calculation unit 38 reads a privacy policy stored in a privacy policy database 42 and registrant data stored in a registrant database 44, and creates access authorization data in advance including an access type list and a registrant condition table. The access authorization data thus created are stored in the memory area 40, for example. In this case, the memory area 40 may include a database which is configured by appropriate software.

The created access authorization data including the access type list and the registrant condition table are stored in the memory area 40 once, and then are made readable by the authorization engine 34. Simultaneously, when it is necessary to provide selection logic for the registrant condition table, the preliminary calculation unit 38 stores such selection logic simultaneously in the memory area 40.

The access management system of the present invention will be explained with reference to FIG. 16 again. A monitoring unit 46 constituting the access management system 30 monitors changes and updates of the data in the privacy policy database 42 and the registrant database 44. Moreover, the monitoring unit 46 monitors consistency of the data between the privacy policy database 42 of the registrant database 44 periodically or continuously, for example. when the registrant changes setting for the condition data or when a new registrant record is added, for example, the monitoring unit 46 extracts a conflicted part of the data to thereby judge the change in the setting of the condition data or the addition of the new registrant record. When the monitoring unit 46 judges that there is the change in setting of the condition data or the addition of the new registrant record, the monitoring unit 46 transmits the changed condition type or the new registrant record to the preliminary calculation unit 38. Upon receipt of the data, the preliminary calculation unit 38 creates access authorization data corresponding to the data and stores difference data in the storage area 40 so that the authorization engine 34 can execute the processing inclusive of the new registrant data.

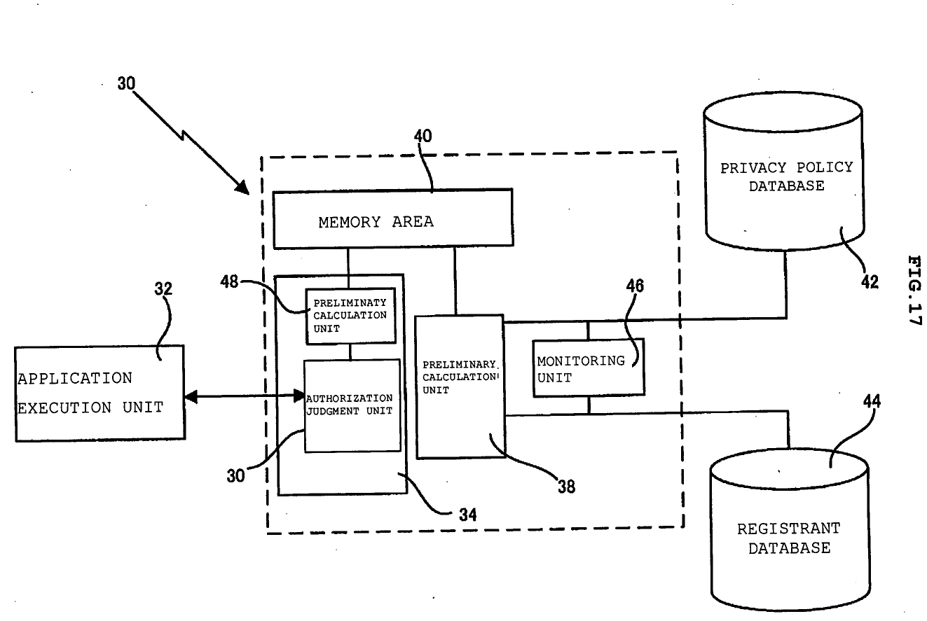

FIG. 17 is a view showing the access management system according to the second embodiment of the present invention. FIG. 17 is the view of the access management system of the second embodiment of the present invention which shows a configuration in the case of performing data compression along an access type axis, a condition data axis, or a registrant axis. The access management system 30 of the present invention includes the authorization engine 34, the preliminary calculation unit 38, and the storage area 40. The authorization engine 34 further includes the authorization judgment unit 36 and a selection module 48 for executing judgment to select each table or list in the access authorization data. The application execution unit 32 executes the processing substantially similar to that described in FIG. 16, and also executes processing for returning a result given by access management to the person in charge.

The authorization engine 34 receives the access request and reads the data such as the data usage type, the business purpose type, or the requested registrant data contained in the access request. Then, the authorization engine 34 decides the requested access type from the data thus read out. Meanwhile, the preliminary calculation unit 38 reads the privacy policy stored in the privacy policy database 42 and the registrant data stored in the registrant database 44, and creates selection logic to enable reference to an authorization/disapproval list or table generated by performing compression processing of the access type list, the registrant condition table and compression data corresponding thereto, and the like. The preliminary calculation unit 38 stores the selection logic in the memory area 40 appropriately constituted including a hard disk, a high-speed access memory (a cache memory).

The selection module 48 receives the decided access type and simultaneously reads the selection logic and the access authorization data out of the storage area 40, and then passes the access authorization data to the authorization judgment unit. The authorization engine 34 enables judgment of authorization or disapproval of the access to the registrant database by use of the access request and the access authorization data thus received. When access is authorized, the application execution unit 32 can obtain the corresponding registrant data. On the contrary, when access is not authorized, the application execution unit 32 receives notification of access disapproval from the authorization engine 34.

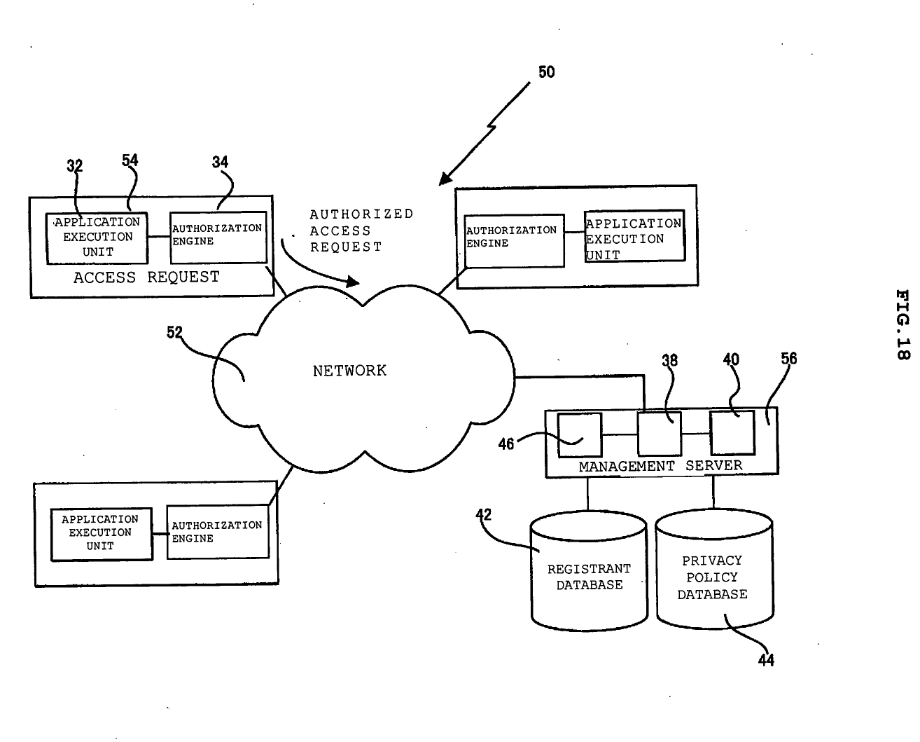

FIG. 18 is a view showing an access management system according to a third embodiment of the present invention. An access management system 50 shown in FIG. 18 is a system configured to manage access to the registrant data through a network such as a local area network (LAN) or a wide area network (WAN). The access management system 50 shown in FIG. 18 includes a network 52, a plurality of application computers 54 connected to the network 52, the registrant database 44, and the privacy policy database 42. In the embodiment described herein, the registrant database 44 and the privacy policy database 42 are managed by a management server 56. Moreover, the management server 56 includes the function as the preliminary calculation unit 38, the function as the monitoring unit 46, and the function as the storage area 40 as described in FIG. 16 and FIG. 17. The management server 56 is capable of calculating in advance and storing the data necessary for executing the access management method of the present invention, such as the access type list, the registrant condition table, or the selection logic. Meanwhile, in the embodiment shown in FIG. 18, each application computer 54 includes the application execution unit 32 and the authorization engine 34.

The access management data required for authorization judgment processing are transmitted to the authorization engine 34 as shown in FIG. 18 from the management server 56 together with data for the selection logic. The data are stored in an appropriate storage area contained in the application computer 54. Each application computer 54 is constituted in such a way that the access request is subjected to the processing of the application computer 64 by use of the stored access authorization data and the access request, and access to the registrant database is controlled by the authorization engine 34. The authorization engine 34 processes the access request based on the above-described access management method of the present invention, and transmits only the access request which passed the appropriateness check to the management server 56. The management server 56 searches and extracts the requested registrant data out of the registrant database 42, and passes the registrant data to the application computer 54.

Incidentally, in another embodiment of the present invention, an authorization server (not shown) can be configured separately without providing the application computer 54 with the function as the authorization engine. Meanwhile, the authorization engine can be configured separately from the management server 56 as a gateway server for processing the access request from the application computer 54. In this way, it is possible to process the access requests from the plurality of application computers 54 independently of the preliminary calculation function.

Although the present invention has been described based on certain embodiments shown in the accompanying drawings, it is not limited to the particular embodiments described herein. Moreover, it is to be noted that the access management method of the present invention can be written as computer-executable programs using various programming languages. Such programming languages include C Language, C++ Language, Java (trademark), and the like. Furthermore, the computer-readable programs for executing the access management method of the present invention can be stored in various recording media for distribution, such as a ROM, an EEPROM, a flash memory, a CD-ROM, a DVD, a flexible disk, or a hard disk.

Application of the present invention can accelerate an appropriateness check of a privacy policy without damaging reliability. Particularly, the overhead of the appropriateness checks constituted a large problem in an application configured to obtain a large amount of information at a time. However, the present invention is particularly effective in such a system accompanying the large amount of data access.

Although the preferred embodiments of the present invention have been described in detail, it should be understood that various changes, substitutions and alternations can be made therein without departing from spirit and scope of the invention as defined by the appended claims. Variations described for the present invention can be realized in any combination desirable for each particular application. Thus particular limitations, and/or embodiment enhancements described herein, which may have particular advantages to the particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What is claimed is:

1. An access management system for managing access to registrant data comprising:
an authorization engine for controlling access to a registrant database storing registrant data including privacy data of a registrant and for controlling access to the registrant database by use of a prescribed privacy policy and condition data designated by the registrant,
wherein the authorization engine includes an authorization judgment unit for deciding an access type from an access request received from outside and concerning the registrant data, for controlling reference to the registrant database based on the access request by use of access authorization data to be decided prior to the access request in connection with the access type.

2. The access management system according to claim 1, further comprising:
a preliminary calculation unit for calculating the access authorization data in advance; and
a storage area for storing the access authorization data.

3. The access management system according to claim 1,
wherein the access authorization data comprises an identification value for executing access authorization which is generated in advance from the privacy policy and the condition data.

4. The access management system according to claim 2,
wherein the access authorization data comprises a table which is generated in advance by use of the privacy policy and the condition data and is written in a format to exclude the access authorization data which are not accessed in response to any of the access type and the condition data designated by the registrant.

5. The access management system according to claim 4,
wherein the access authorization data further comprises an authorization list and a disapproval list.

6. An access management method for managing access to registrant data by use of a computer system, the method includes the steps of:
causing an authorization engine to receive an access request from outside;
causing the authorization engine to decide an access type from the access request;
reading access authorization data to be decided prior to the access request in connection with the access type concerning the registrant data and comparing the access authorization data with the access type; and
controlling reference to a registrant database associated with the access request based on the comparison.

7. The access management method according to claim 6, further comprising the step of:
storing in a storage area the access authorization data including an identification value for executing access authorization created by a creation unit.

8. The access management method according to claim 6, further comprising the step of:
storing in a storage area access authorization data including a table which excludes the access authorization data not accessed in response to an access type or the condition data designated by a registrant, by use of a privacy policy and condition data.

9. The access management method according to claim 8, further comprising the step of:
storing an authorization list and a disapproval list in the storage area in addition to the access authorization data.

10. A computer-executable program for causing a computer to execute the access management method according to claim 6.

11. A computer-readable recording medium storing the computer-executable program according to claim 10.

12. An access management system for managing access to registrant data through a network, comprising:
a network;
a registrant database connected to the network that stores the registrant data containing privacy of a registrant;
an authorization engine connected to the network for controlling the access to the registrant database by use of an application execution unit for issuing an access request to the registrant database and by use of a given privacy policy relevant to the registrant data and condition data designated by the registrant upon receipt of an access request from the application execution unit; and
a management server for generating access authorization data to be decided prior to the access request in connection with an access type and for causing the authorization engine to use the access authorization data.

13. The access management system according to claim 12,
wherein the authorization engine controls the access by use of the access authorization data including an identification value, which is generated by use of the privacy policy and the condition data and includes an identification value for executing access authorization.

14. The access management system according to claim 12,
wherein the authorization engine controls the access by use of a table in a format arranged to exclude the access authorization data not accessed in response to any of the access type and the condition data designated by the registrant by use of the privacy policy and the condition data, and by use of the access authorization data including an access list and a disapproval list.

15. An access controlling method for controlling a computer to manage access to registrant data through a network, the access management method comprising the steps of:
causing an authorization engine to use access authorization data calculated in advance through the network;
causing the authorization engine to receive an access request from outside to a registrant database storing the registrant data containing privacy of the registrant;
deciding an access type upon receipt of the access request from the outside; and
controlling the access to the registrant database by comparing the access type decided as described above with the access authorization data decided prior to the access request.

16. The access management method according to claim 15,
wherein the access authorization data are generated by use of a privacy policy and condition data and includes an identification value for executing access authorization.

17. The access management method according to claim 15,
wherein the access authorization data includes a table in a format arranged to exclude the access authorization data not accessed in response to any of the access type and condition data designated by the registrant, an access list, and a disapproval list by use of the privacy policy and the condition data.

18. An article of manufacture comprising a computer usable medium having computer readable program code means embodied therein for causing for managing access to registrant data by use of a computer system, the computer readable program code means in said article of manufacture comprising computer readable program code means for causing a computer to effect the steps of claim 6.

19. A program storage device readable by machine, tangibly embodying a program of instructions executable by the machine to perform method steps for managing access to registrant data by use of a computer system, said method steps comprising the steps of claim 6.

20. A computer program product comprising a computer usable medium having computer readable program code means embodied therein for causing management of access to registrant data, the computer readable program code means in said computer program product comprising computer readable program code means for causing a computer to effect the functions of claim 1.

21. A computer program product comprising a computer usable medium having computer readable program code means embodied therein for causing management of access to registrant data through a network, the computer readable program code means in said computer program product comprising computer readable program code means for causing a computer to effect the functions of claim 12.
